(19) United States
(12) Patent Application Publication
(10) Pub. No.: US 2026/0243995 A1
(43) Pub. Date: Aug. 20, 2026

(54) LARGE ANGLE COMPACT OPTICAL IMAGE STABILIZATION FOR FOLDED CAMERAS

(71) Applicant: Corephotonics Ltd., Tel Aviv (IL)

(72) Inventors: Yiftah Kowal, Tel Aviv (IL); Ephraim Goldenberg, Tel Aviv (IL); Tom Weitz, Tel Aviv (IL); Oriel Grushka, Tel Aviv (IL)

(21) Appl. No.: 19/635,821

(22) Filed: Apr. 1, 2026

Related U.S. Application Data
(63) Continuation of application No. 18/858,827, filed on Feb. 8, 2024, now Pat. No. 12,645,051.
(60) Provisional application No. 63/485,071, filed on Feb. 15, 2023.
(60) Provisional application No. 63/515,593, filed on Jul. 26, 2023.
(60) Provisional application No. 63/580,998, filed on Sep. 7, 2023.

(51) Int. Cl. G02B 7/182; G02B 27/64

(52) U.S. Cl. CPC G02B 7/1827; G02B 27/646

(57) ABSTRACT

Folded camera modules, comprising: an optical path folding element (OPFE) for folding light from a first optical path toward a second optical path that is substantially orthogonal to the first optical path; a lens with a lens optical axis along the second optical path and an effective focal length in the range of 5-40 mm; an image sensor; a module frame with an inner wall pointing towards the OPFE and having a module height H_{M}, a module length L_{M} and a module width W_{M}; and an OPFE actuator for rotating the OPFE around a first rotation axis and around a second rotation axis that is perpendicular to the first rotation axis to perform optical image stabilization (OIS) by more than ±1 degrees around respectively, a first OIA direction and a second OIS direction, wherein a minimum distance Y_{Min} between the OPFE and the inner wall of the module frame in an extreme rotation OPFE position measured along a direction parallel to the second optical path fulfills Y_{Min}≤2 mm, wherein Y_{Min}/L_{M}≤0.075, wherein a minimum distance X_{MIN} between the OPFE and the inner wall of the module frame in an extreme rotation OPFE position measured along a direction perpendicular to both the first optical path and the second optical path fulfills X_{Min}≤3 mm, and wherein X_{Min}/W_{M}≤0.25.

### CROSS REFERENCE TO RELATED APPLICATIONS

This application is a continuation of U.S. patent application Ser. No. 18/858,827 filed Oct. 22, 2024 (now allowed), which was a 371 application from international patent application PCT/IB2024/051156 filed Feb. 8, 2024, which was related to and claims priority from U.S. Provisional Patent Applications 63/485,071 filed Feb. 15, 2023, 63/515,593 filed Jul. 26, 2023, and 63/580,998 filed Sep. 7, 2023, all of which are incorporated herein by reference in their entirety.

### FIELD

Examples disclosed herein relate in general to digital cameras and in particular to optical stabilization of images obtained with folded digital cameras.

### BACKGROUND

Compact digital cameras having folded optics and referred to as “folded cameras” are known, see e.g. co-owned international patent application PCT/IB2016/057366. In handheld mobile electronic devices (or simply “mobile devices”) such as smartphones, tablets, etc., a folded Tele (T) camera (also referred to herein as “FTC”) is often part of a multi-camera system and accompanied by one or more additional cameras, e.g. an Ultra-wide (UW) camera and/or a Wide (W) camera. An Ultra-wide camera has a larger field of view (FOV_{UW}) than that of a Wide camera (FOV_{W}), where FOV_{W} is larger than a FOV_{T} of a folded Tele camera.

FIG. 1A shows schematically a dual camera 100 as known in the art in a perspective view. Dual camera 100 includes a FTC 101 and a regular (or vertical) camera 130. FTC 101 includes an optical path folding element (OPFE) 102, an image sensor 106 and a lens (not shown) held in a lens barrel 110. The optical axis of the lens is marked 108. OPFE 102 is operational to fold a first optical path (OP1) 112 into a second optical path (OP2) 114, where OP2 114 is substantially parallel to the lens optical axis 108. Camera 130 may be a W camera or a UW camera. Camera 130 includes a lens 132 held in a lens barrel 134, and an image sensor 138. The optical axis of lens 132 is marked 136 and is oriented parallel to OP1 112. In the x-y-z coordinate axis shown, OP1 112 is oriented parallel to the y-axis and OP2 114 is oriented parallel to the z-axis.

Scanning zoom cameras (“SZ” cameras or “SZCs”) are known, see e.g. co-owned international patent application PCT/IB2016/057366. FIG. 1B shows schematically a FOV 140 of a dual camera, which includes a FOV_{W} 142 of a Wide camera and a FOV_{SZ} 144 of a scanning zoom camera. As shown, FOV_{SZ} 144 can scan (or move) within FOV_{W} 142 in two dimensions, as indicated by four arrows. A compact and cost-effective way of implementing a SZC operational to scan two dimensions is to rotate (or “tilt”) an OPFE (e.g. a prism) of a folded zoom camera along two rotation axes. However, this introduces “point of view (POV) aberrations”, which must be corrected after capturing a respective SZC image, for example as detailed in the co-owned international patent application PCT/IB2021/056311. Overall, the presence of POV aberrations increases a dual camera's complexity and carries the risk of imperfect correction.

Modern cameras such as dual camera 100 in general include optical image stabilization (OIS) for mitigating undesired camera motion caused by a user's hand motion (often referred to as handshake). For OIS, optical components are moved to reduce movements of imaged objects on the camera's image sensor. In other words, a FOV is moved so that it is stabilized on the image sensor. Often, an OPFE such as OPFE 102 is moved for OIS with respect to the lens and to the image sensor (“prism OIS”). An inertial measurement unit (IMU) as known in the art and included in a mobile device including also dual camera 100 may provide motion data of the mobile device. For example, the motion data of the mobile device may be of 6 degrees of freedom. The motion data of the mobile device may be used for providing OIS. For OIS along a first (“Yaw”) direction, OPFE 102 is rotated around a yaw rotation axis 112 which is parallel to OP1 112. For OIS along a second (“Pitch”) direction, OPFE 102 is rotated around a pitch rotation axis 116 which is parallel to the x-axis and perpendicular to both OP1 112 and OP2 114. For improving the image quality of a folded camera such as folded camera 101 even in harsh scenarios such as relatively strong undesired camera motion, relatively large FOV movement of e.g. ±1 degree or more along the yaw direction and the pitch direction respectively are required. To provide the relatively large FOV movements, in general relatively large actuators and/or large camera modules are required.

There is a need for and it would be advantageous to have a large movement prism OIS actuator. In addition, it would be advantageous to have a dual camera including a SZC which does not create POV aberrations.

### SUMMARY

In various exemplary embodiments there is provide a folded camera module, comprising: an OPFE for folding light from a first optical path toward a second optical path that is substantially orthogonal to the first optical path, a lens with a lens optical axis along the second optical path, the lens having an effective focal length EFL in the range of 5-40 mm; an image sensor; a module frame surrounding the folded camera module, the module frame having an inner wall pointing towards the OPFE, a module height H_{M} measured along a direction parallel to the first optical path, a module length L_{M} measured along a direction parallel to the second optical path and a module width W_{M} measured along a direction perpendicular to both the first optical path and the second optical path; an OPFE actuator including a single voice coil motor (VCM) for rotating the OPFE around a first rotation axis and around a second rotation axis that is perpendicular to the first rotation axis to perform OIS around respectively, a first OIS direction and a second OIS direction, wherein the OIS is by more than ±1 degrees around each of the first OIS direction and the second OIS direction, wherein a minimum distance Y_{Min} between the OPFE and the inner wall of the module frame in an extreme rotation OPFE position measured along a direction parallel to the second optical path fulfills Y_{Min}≤2 mm, wherein Y_{Min}/L_{M}≤0.075, wherein a minimum distance X_{MIN} between the OPFE and the inner wall of the module frame in an extreme rotation OPFE position measured along a direction perpendicular to both the first optical path and the second optical path fulfills X_{Min}≤3 mm, and wherein X_{Min}/W_{M}≤0.25.

In some examples, the rotation of the OPFE around the first rotation axis uses three support positions.

In some examples, the first rotation axis is located within an area that also includes the OPFE.

In some examples, the second rotation axis is located within an area that also includes the OPFE.

In some examples, Y_{Min}/L_{M}≤0.05. In some examples, X_{Min}/W_{M} is ≤0.2. In some examples, X_{Min}≤2.75 mm and Y_{Min}≤1.75 mm. In some examples, X_{Min}≤2.5 mm and Y_{Min}≤1.5 mm. In some examples, X_{Min}≤2.25 mm and Y_{Min}≤1.25 mm.

In some examples, the OIS may be by more than ±2 degrees around each of the first OIS direction and the second OIS direction. In some examples, the OIS may be by more than ±3 degrees around each of the first OIS direction and the second OIS direction. In some examples, the OIS may be by more than ±4 degrees around each of the first OIS direction and the second OIS direction. In some examples, the OIS may be by more than ±5 degrees around each of the first OIS direction and the second OIS direction.

In some examples, the OPFE is a prism.

In some examples, W_{M} may be in the range of 7.5-15 mm and L_{M} may be in the range of 15-30 mm. In some examples, H_{M} may be in the range of 4-15 mm. In some examples, H_{M} may be in the range of 5-10 mm.

In some examples, the OPFE has an OPFE height H_{P} measured along a direction parallel to the first optical path and an OPFE width W_{P} measured along a direction perpendicular to both the first optical path and the second optical path, wherein in a zero-rotation OPFE position the OPFE is located at a horizontal distance h-D_{PH} and at a vertical distance v-D_{PH} away from the inner wall of the module frame, and wherein W_{P}/h-D_{PH}>1.75 and H_{P}/v-D_{PH}>1.75.

In some examples, W_{P}/h-D_{PH}>2 and H_{P}/v-D_{PH}>2. In some examples, W_{P}/h-D_{PH}>2.5 and H_{P}/v-D_{PH}>2.5. In some examples, W_{P}/h-D_{PH}>3 and H_{P}/v-D_{PH}>3. In some examples, W_{P}/h-D_{PH}>3.25 and H_{P}/v-D_{PH}>3.25.

In some examples, H_{M}<H_{P}+4 mm. In some examples, H_{M}<H_{P}+2.5 mm.

In some examples, a ratio H_{P}/H_{M} may be in the range of 0.7-0.8.

In some examples, W_{P} may be in the range of 3-20 mm.

In some examples, EFL may be in the range of 10-25 mm.

In some examples, the OPFE actuator includes a yaw stage, a pitch stage and a frame, and the yaw stage, the pitch stage and the frame move relatively to each other. In some examples, the pitch stage moves together with the yaw stage.

In some examples, the yaw stage includes two magnets, and the frame includes two coils, a first coil and a second coil. In some examples, the frame and the module frame are made of one part. In some examples, the yaw stage includes a position sensing unit comprising one or more magnets. In some examples, the pitch stage includes a position sensing unit comprising two or more magnets. In some examples, the relative movement between the yaw stage, the pitch stage and the frame is enabled by a plurality of ball bearings.

In some examples, for rotating the OPFE around the second rotation axis, a current in the first coil is flowing in an identical direction with a current in the second coil. In some examples, for rotating the OPFE around the first rotation axis, a current in the first coil is flowing in an opposite direction than a current in the second coil.

In some examples, the folded camera module may be included in a mobile device. In some examples, the mobile device also comprises a Wide camera having a Wide camera field of view FOV_{W} larger than FOV_{T}. In some examples, the mobile device also comprises an IMU. In some examples, the mobile device may be a smartphone. In some examples, the mobile device may be a tablet.

### BRIEF DESCRIPTION OF THE DRAWINGS

Non-limiting examples of embodiments disclosed herein are described below with reference to figures attached hereto that are listed following this paragraph. The drawings and descriptions are meant to illuminate and clarify embodiments disclosed herein, and should not be considered limiting in any way. Like elements in different drawings may be indicated like numerals.

FIG. 1A shows schematically a known dual camera including a folded camera;

FIG. 1B shows schematically a known dual camera field-of-view including a folded scanning zoom camera field-of-view;

FIG. 2A shows a folded camera module including a folded camera operational for large stroke OIS as disclosed herein in a perspective view;

FIG. 2B shows the folded camera module of FIG. 2A without a top shield in the same view;

FIG. 2C shows the folded camera module of FIG. 2B in a top view;

FIG. 3A shows a yaw stage in a top view;

FIG. 3B shows the yaw stage in a bottom view;

FIG. 3C shows the yaw stage in a perspective view;

FIG. 3D shows a frame (or housing) of the folded camera module of FIGS. 2A-C in a top view;

FIG. 3E shows the frame in a perspective view;

FIG. 3F shows the folded camera module of FIG. 2A in a side view;

FIG. 3G shows a top part of the folded camera module of FIGS. 2A-C in a top view;

FIG. 3H shows a top part of the folded camera module of FIGS. 2A-C with an OPFE shown in a Yaw_{Max}-state with respect to a yaw rotation axis;

FIG. 3I shows the yaw stage without the OPFE in a Yaw_{Max}-state with respect to the yaw rotation axis;

FIG. 3J shows a top part of the folded camera module of FIGS. 2A-C with the OPFE shown in a “Yaw_{Min}-state” with respect to the yaw rotation axis;

FIG. 3K shows the yaw stage without the OPFE in a Yaw_{Min}-state with respect to the yaw rotation axis;

FIG. 3L shows a voice coil motor (VCM) disclosed herein in a perspective view;

FIG. 3M shows the VCM of FIG. 3L included in the folded camera module of FIGS. 2A-C in a bottom view;

FIG. 3N shows the VCM of FIG. 3L included in an OPFE holder in a perspective bottom view;

FIG. 4A shows a pitch stage of the folded camera module of FIGS. 2A-C and including the OPFE in a front view;

FIG. 4B shows the pitch stage and the OPFE of FIG. 4A in a side view, with the OPFE shown in a “pitch zero state” with respect to a pitch direction;

FIG. 4C shows the pitch stage in a side view with the OPFE shown in a Pitch_{Max}-state with respect to the pitch rotation axis;

FIG. 4D shows the pitch stage in a side view with the OPFE shown in a Pitch_{Min}-state with respect to a pitch rotation axis.

FIG. 5A shows another pitch stage disclosed herein in a side view, with the OPFE shown in a yaw zero state with respect to a yaw rotation axis;

FIG. 5B shows the pitch stage of FIG. 5A in a perspective view, with the OPFE shown in a yaw zero state with respect to a rotation axis;

FIG. 5C shows the pitch stage of FIG. 5A included in a frame in a perspective view and in a Yaw_{Min}-state with respect to a yaw rotation axis;

FIG. 5D shows the pitch stage of FIG. 5A included in a frame in a perspective view and in a Yaw_{Max}-state with respect to the yaw rotation axis.

FIG. 6A shows a scanning zoom camera (SZC) as disclosed herein in a perspective view;

FIG. 6B shows a component of the SZC shown in FIG. 6A in a side view;

FIG. 6C shows the component shown in FIG. 6B in a perspective view;

FIG. 7A shows the SZC of FIG. 6A in a first extreme rotation state with respect to a second rotation axis in a perspective view;

FIG. 7B shows the SZC of FIG. 6A in a center rotation state with respect to a second rotation axis in a perspective view;

FIG. 7C shows the SZC of FIG. 6A in a second extreme rotation state with respect to a second rotation axis in a perspective view;

FIG. 8A shows the component shown in FIG. 6B in a first extreme rotation state with respect to a second rotation axis in a side view;

FIG. 8B shows the component shown in FIG. 6B in a center rotation state with respect to a second rotation axis in a side view;

FIG. 8C shows component shown in FIG. 6B in a second extreme rotation state with respect to a second rotation axis in a side view;

FIG. 9A shows the component shown in FIG. 6B in a first extreme rotation state with respect to a first rotation axis in a side view;

FIG. 9B shows the component shown in FIG. 6B in a center rotation state with respect to a first rotation axis in a side view;

FIG. 9C shows component shown in FIG. 6B in a second extreme rotation state with respect to a first rotation axis in a side view;

FIG. 10A shows another component of the SZC shown in FIG. 6A in a side view in a side view;

FIG. 10B shows the component shown in FIG. 10A in a first perspective view;

FIG. 10C shows the component shown in FIG. 10A in a second perspective view.

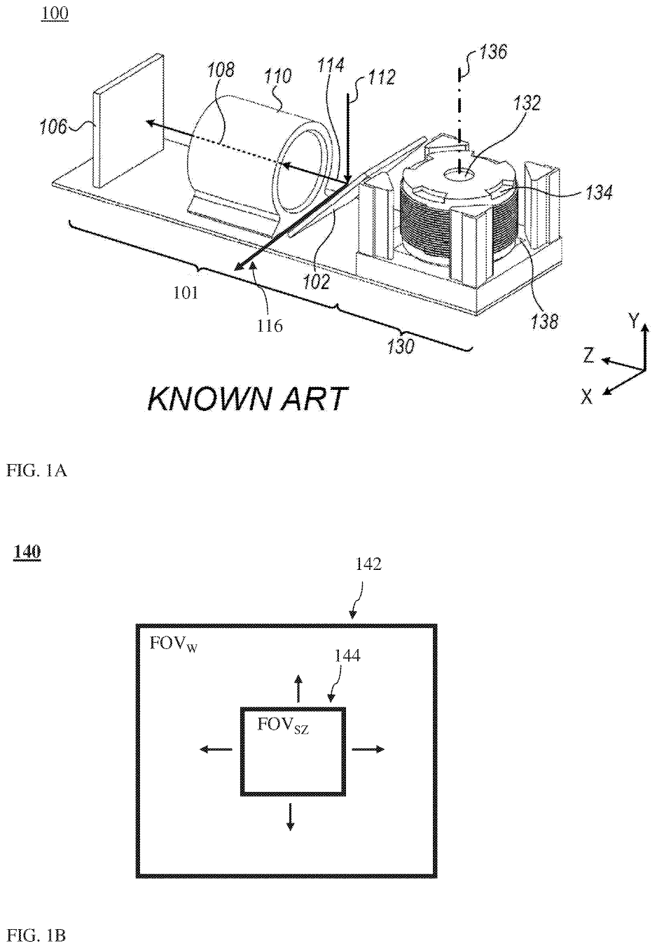

### DETAILED DESCRIPTION

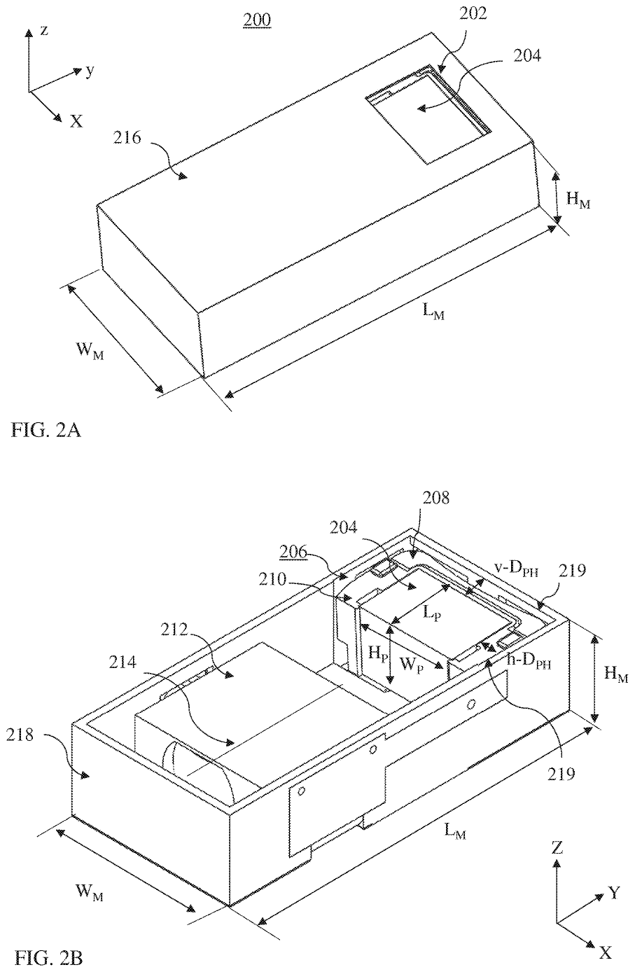

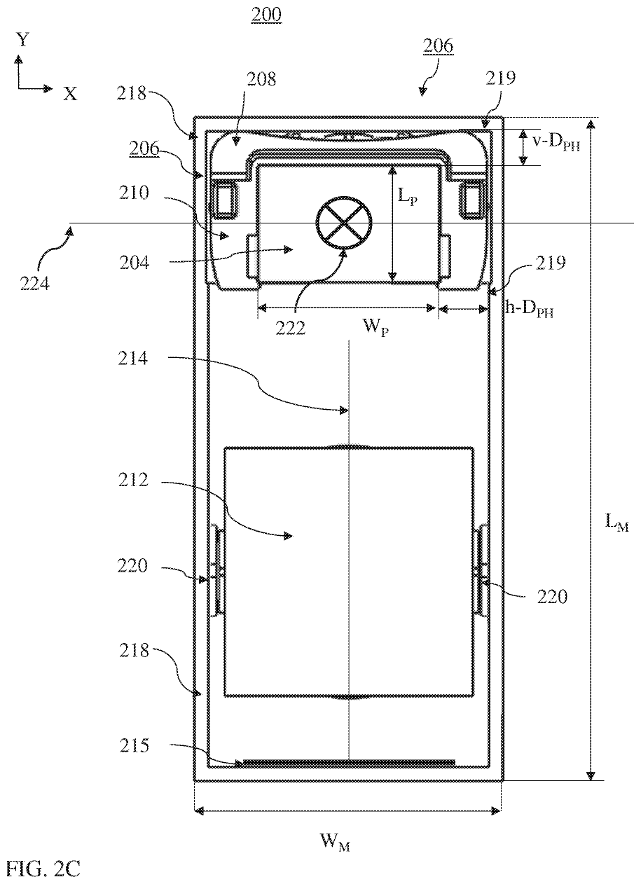

FIG. 2A shows an embodiment of a folded camera module numbered 200 that comprises a folded camera operational for large stroke OIS as disclosed herein in a perspective view. Folded camera module 200 has an aperture 202 formed (or defined or determined) by an OPFE 204 included in an OPFE holder 206 (FIGS. 2B, C). Folded camera module 200 further includes a lens barrel 212 with a lens (not shown) having a lens optical axis 214, and an image sensor 215 (FIG. 2C). The lens may have an effective focal length (“EFL”) in the range of 5 mm-40 mm, or in the range of 10 mm to 25 mm. Folded camera module 200 is covered by a top shield 216. A length L_{M}, a width W_{M} and a height H_{M} of folded camera module 200 are marked. Folded camera module 200 is operational to perform large stroke OIS by rotating prism 204 around a first, yaw rotation axis 222 and a second, pitch rotation axis 224 by ±1 degree or more. Rotating prism 204 around the two rotation axes can be used to achieve two effects:
1. To change the position of the FOV of the folded camera included in folded camera module 200, i.e. to scan a scene with the FOV of the folded camera.
2. To mitigate an undesired handshake of a mobile device that includes folded camera module 200 (around two axes).

FIG. 2B shows folded camera module 200 without top shield 216 in another perspective view. FIG. 2C shows folded camera module 200 without top shield 216 in a top view. Folded camera module 200 is surrounded by a module frame (or simply “frame” or “housing”) 218. Frame 218 has two different functions: 1) acting as a bottom shield (or housing) of folded camera module 200, i.e. frame 218 surrounds large parts of camera components included in folded camera module 200; and 2) acting as a stationary part of OPFE holder 206, which engages with (or interacts with) a yaw stage and a pitch stage 210 for actuating OPFE 204 as described below. Frame 218 may for example be made of plastic. Here, OPFE 204 is a prism. In other examples, OPFE 204 may be a mirror. OPFE 204 has an OPFE (i.e. prism) length L_{P}, an OPFE width W_{P} and an OPFE height H_{P}, as marked.

In FIGS. 2B-C, OPFE 204 is shown in a zero-rotation state. “Zero-rotation state” refers here to a state that represents (1) a center of a pitch rotation stroke defined by a minimum pitch rotation angle Pitch_{Min} and by a maximum pitch rotation angle Pitch_{Max}, and (2) a center of a yaw rotation stroke defined by a minimum yaw rotation angle Yaw_{Min} and a maximum pitch rotation angle Yaw_{Max}. In the zero-rotation state, “borders” (i.e. edges or surfaces) of OPFE 204 are oriented parallel to an inner wall (or surface) 219 of frame 218. In the zero-position, OPFE 204 is located at a “vertical” distance v-D_{PH} and a “horizontal” distance h-D_{PH} from inner wall 219 of frame 218, as shown. The same holds for all other borders mentioned.

With reference to FIG. 2C, “horizontal” refers here to the fact that h-D_{PH} is measured along a horizontal direction (parallel to the x-axis in the x-y-z coordinate system shown), and “vertical” refers here to the fact that v-D_{PH} is measured along a vertical direction (parallel to the y-axis). Yaw rotation axis 222 is oriented perpendicular to the coordinate system shown in FIG. 2C, and pitch rotation axis 224 is oriented parallel to the x-axis. Yaw rotation axis 222 is located (or positioned) within an area that also includes OPFE 204. Rotating OPFE 204 by 1 degree around yaw rotation axis 222 and pitch rotation axis 224 respectively moves the FOV of the folded camera by 1 degree in a yaw rotation direction and by 2 degrees in a pitch rotation direction, as known in the art. I.e., to achieve a FOV movement of angle α in both the yaw rotation direction and the pitch rotation direction, one rotates OPFE 204 by α around yaw rotation axis 222 and by 0.5× α around pitch rotation axis 224. Here, the FOV movement is to perform OIS.

For a compact camera, it is advantageous to minimize both v-D_{PH} and h-D_{PH}. In some examples, folded camera module 200 and OPFE 204 may have the following dimensions:

$${L}_{M} = 29 mm , {W}_{M} = 13.5 mm , and {H}_{M} = 6.8 mm .$$

$${L}_{P} = {H}_{P} = 5 mm , {W}_{P} = 7.8 mm .$$

$$v - {D}_{PH} = 1.5 mm , h - {D}_{PH} = 2.2 mm .$$

These yield ratios W_{P}/h-D_{PH}=3.5 and H_{P}/v-D_{PH}=3.3 and H_{P}/H_{M}=0.74 H_{M}=H_{P}+1.8 mm. In other examples, ratio H_{P}/H_{M} may be in the range of 0.6-0.9 and H_{M}<H_{P}+4 mm may be fulfilled. In yet other examples, ratio H_{P}/H_{M} may be in the range of 0.7-0.8 and H_{M}<H_{P}+2.5 mm or H_{M}<H_{P}+2 mm may be fulfilled.

In other examples of folded camera modules including a folded camera operational for large stroke OIS, values and ranges may be as given in Table 1.

OPFE holder 206 is divided into three parts, which can rotationally move relative to each other for actuating OPFE 204: a Yaw stage 208, frame 218 and a pitch stage 210. As described in the following, the relative movements are as follows:
Yaw stage 208 rotates around yaw rotation axis 222 relatively to frame 218 for OIS around a first OIS direction (“yaw rotation direction”).
When yaw stage 208 rotates relatively to frame 218, pitch stage 210 moves together with (or “rides on”) Yaw stage 208.
Pitch stage 210 rotates around pitch rotation axis 224 relatively to yaw stage 208 and relative to frame 218 for OIS around a second OIS direction (“pitch rotation direction”). In addition, folded camera module 200 includes a lens actuator 220 which is operational to move lens barrel 212 with the lens. For example, lens actuator 220 may move lens barrel 110 along an axis parallel to lens optical axis 214 for focusing.

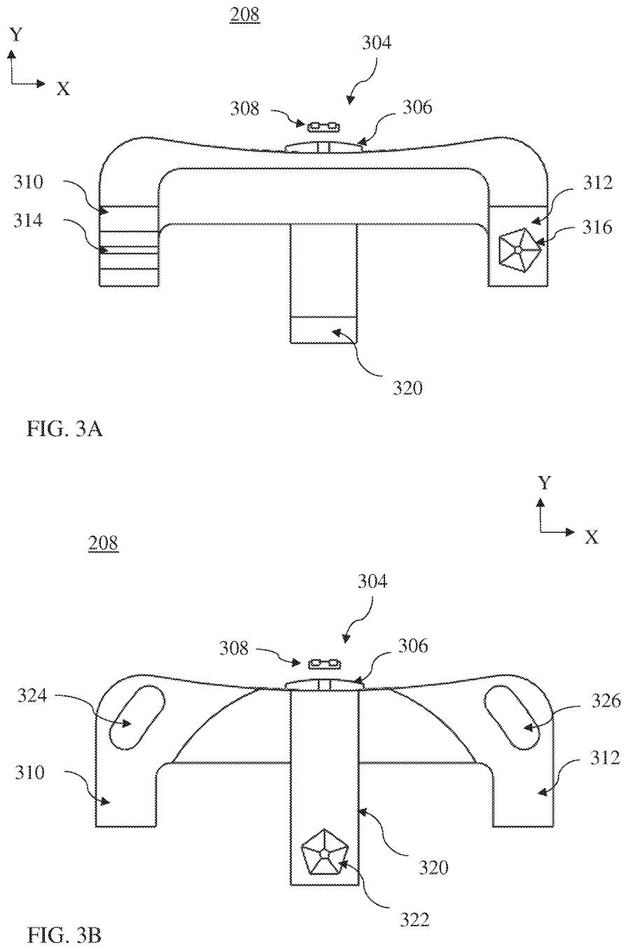

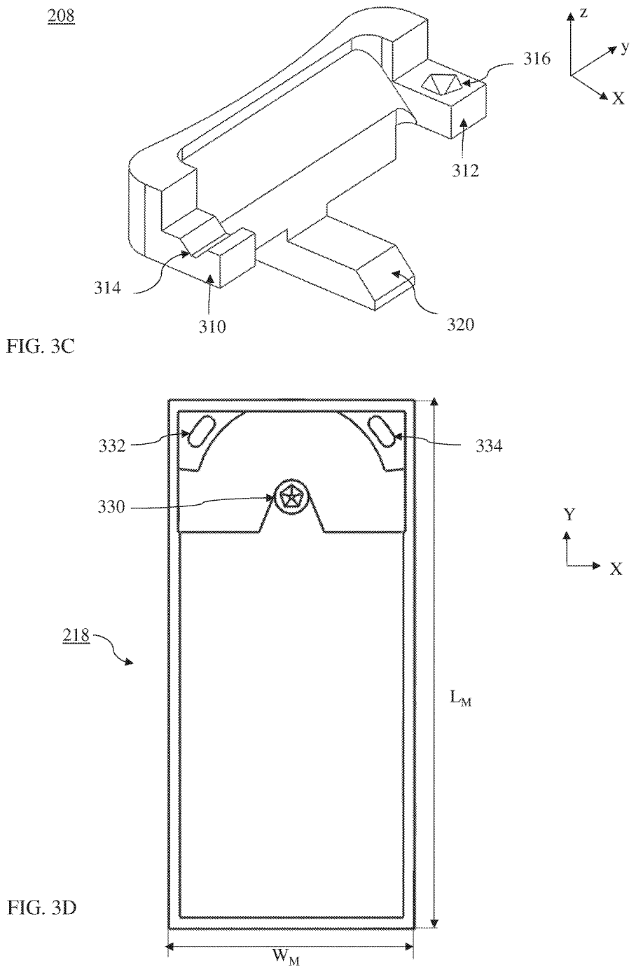

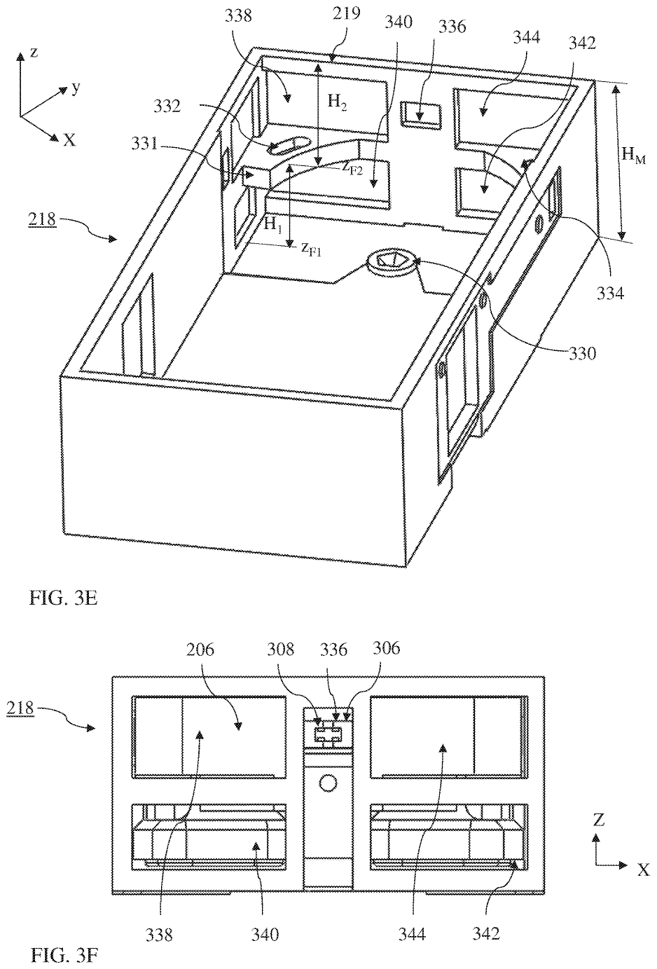

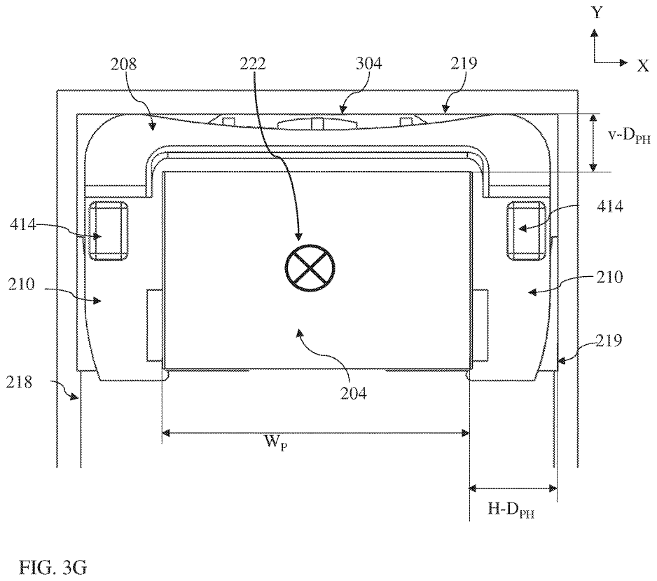

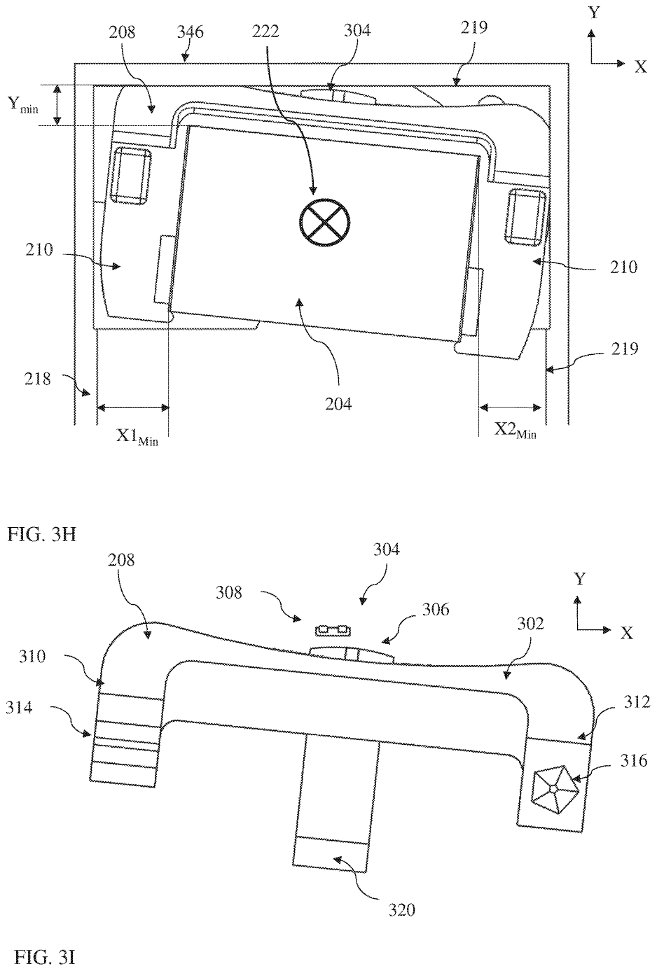

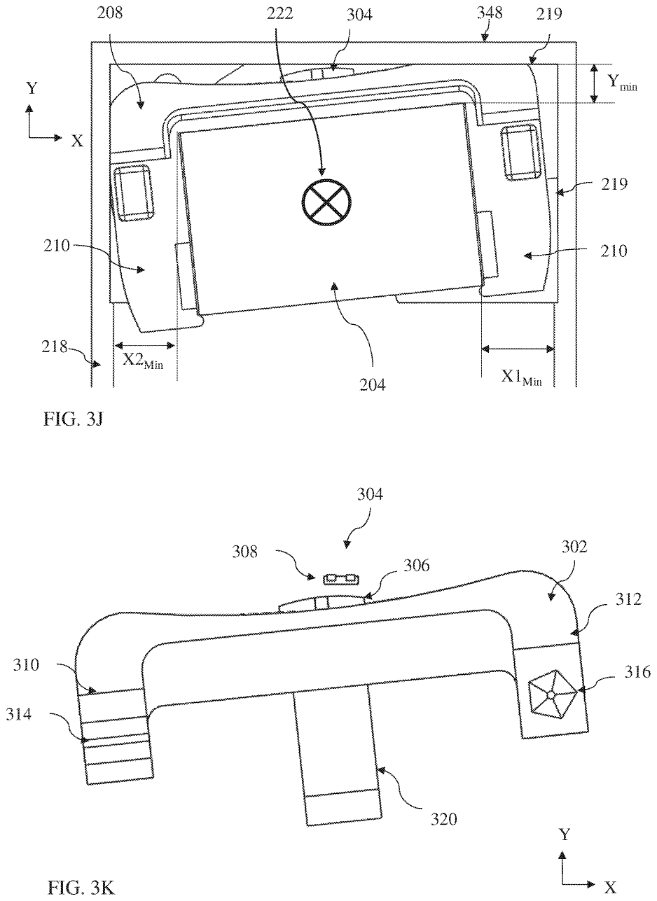

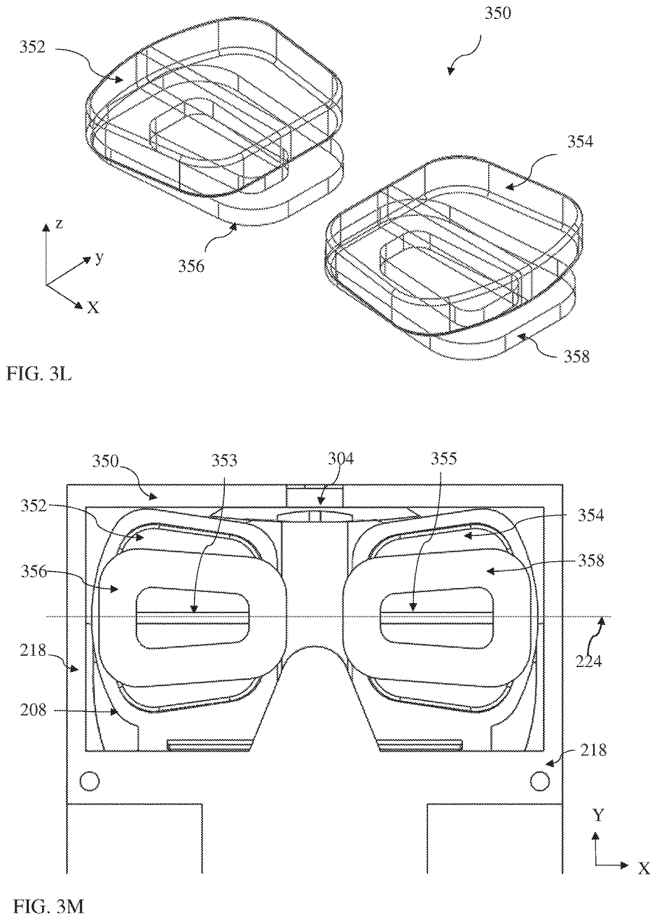

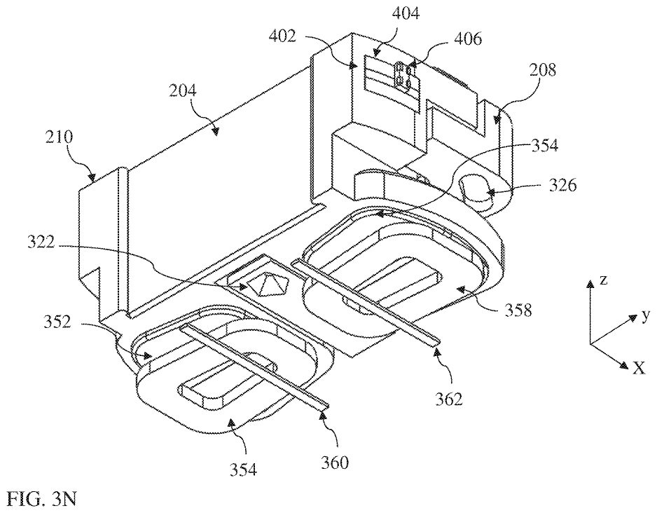

FIG. 3A shows yaw stage 208 in a top view. Yaw stage 208 is shown without OPFE 204 for better visibility. Yaw stage 208 includes a yaw position sensing unit (PSU) 304 which includes a magnet 306 fixedly coupled to yaw stage 208 and a magnetic flux measuring device (MFMD) 308 fixedly coupled to frame 218. Yaw PSU 304 is operational to sense a relative movement between yaw stage 208 and frame 218. Yaw stage 208 has a left arm 310, a right arm 312 and a center arm 320. A top side of yaw stage 208 comprises a groove 314 included in left arm 310 and a cavity (or hole) 316 included in right arm 312.

FIG. 3B shows yaw stage 208 (without OPFE 204) in a bottom view. A bottom side of yaw stage 208 comprises a cavity 322 in center arm 320, a first hole (or void) 324 in left arm 310 and a second hole 326 in right arm 312.

FIG. 3C shows yaw stage 208 in a perspective view. Groove 314 included in left arm 310 and a cavity 316 in right arm 312 are visible.

FIG. 3D shows frame 218 of folded camera module 200 in a top view. FIG. 3E shows frame 218 in a perspective view. Frame 218 includes a cavity 330, a third hole 332 and a fourth hole 334. Yaw stage 208 can be moved relative to frame 218 by means of three ball-bearings: a first ball-bearing is formed by confining a first ball (not shown) within a first closed volume formed by first hole 324 (included in yaw stage 208) and third hole 332 (included in frame 218); a second ball-bearing is formed by confining a second ball (not shown) within a second volume formed by second hole 326 (included in yaw stage 208) and fourth hole 334 (included in frame 218); and a third ball-bearing is formed by confining a third ball (not shown) within a third volume formed by cavity 322 (included in yaw stage 208) and cavity 330 (included in frame 218). The location of the first ball-bearing is defined by first hole 324, the location of the second ball-bearing is defined by cavity 316 and the location of the third ball-bearing is defined by cavity 322. When prism 204 rotates around yaw rotation axis 222, the third ball-bearing acts as a pivot point (representing a first support position), and both the first and the second ball-bearings act as rails (representing a second and a third support position). This means that overall, rotating prism 204 around yaw rotation axis 222 uses three support positions.

The third ball-bearing is positioned at a first position “Z_{F1}” (along the z-axis) which is relatively close to a bottom of frame 218 when compared to the position of the first and second ball-bearings, “bottom” referring to a lowest dimension of frame 218 along the z-axis. Relative to the third ball-bearing, the first ball-bearing and the second ball-bearing are positioned at a same second elevated position “Z_{F2}” (along the z-axis), as shown. We refer to the first position as a “first floor”, and to the second position as a “second floor”. The first floor is distanced by a first distance (or height) H₁ along the z-axis from the second floor. The second floor is distanced by a second distance (or height) H₂ from a top of frame 218. As shown, H₁≈H₂≈H_{M}/2. It is noted that positioning the first ball-bearing and the second ball-bearing at the second floor is advantageous, because it leaves a free space or free volume in the first floor. A front surface of the first floor is marked 331.

In some examples and as shown, magnet 306 has a circular (or “round”) shape. The circular shape may be such that the shape of magnet 306 is concentric with respect to the pivot point. The circular shape is advantageous for measuring exactly a rotation around yaw rotation axis 222, i.e. for providing an accurate Yaw PSU 304. This is because the distance (air gap) between magnet 306 and MFMD 308 is relatively constant, i.e. it changes only by a relatively small amount. In other examples, magnet 306 may have a rectangular (or “flat”) shape. The flat shape may be advantageous for manufacturing a low-cost folded camera module 200.

FIG. 3F shows frame 218 of folded camera module 200 in a side view. Frame 218 includes a first notch 336, a second notch 338, a third notch 340, a fourth notch 342 and a fifth notch 344. Because of notch 336, MFMD 308 can measure a magnetic field of magnet 306.

FIG. 3G shows a top part of folded camera module 200 in a top view. OPFE 204 is shown in “yaw zero-state” with respect to yaw rotation axis 222. “Yaw zero-state” refers here to an OPFE yaw rotation state that represents a center of a yaw rotation stroke defined by a minimum yaw rotation angle Yaw_{Min} and a maximum yaw rotation angle Yaw_{Max}.

FIG. 3H shows a top part of folded camera module 200 with OPFE 204 shown in the Yaw_{Max}-state with respect to yaw rotation axis 222. “Yaw_{Max}-state” refers here to an OPFE yaw rotation state that represents a first extreme (here, a maximum) yaw rotation angle. In the Yaw_{Max}-state, OPFE 204 is located at a minimum distance Y_{Min} measured along the y-axis, a first minimum distance X1_{Min} measured along the x-axis, and a second minimum distance X2_{Min} measured along the x-axis away from an inner boundary (or border) of frame 218, as shown. In folded camera module 200, Y_{Min}=1.1 mm, X1_{Min}=2.0 mm and X2_{Min}=1.9 mm. A ratio Y_{Min}/L_{M} when L_{M}=29 mm) is Y_{Min}/L_{M}=0.037. Ratios of X1_{Min}/W_{M} and X2_{Min}/W_{M} when W_{M}=13.5 mm are X1_{Min}/W_{M}=0.148 and X2_{Min}/W_{M}=0.141.

In other examples, minimum distances such as distances X1_{Min} and X2_{Min} may be equal to or smaller that 5 mm, or more advantageously ≤3 mm, or ≤2.75 mm, or ≤2.5 mm or even 2.25 mm. The ratio X_{Min}/W_{M} may be in the range of 0.05 to 0.25. Y_{Min} may be ≤5 mm, or more advantageously ≤2 mm, or ≤1.75 mm, or ≤1.5 mm or even ≤1.25 mm. The ratio Y_{Min}/L_{M} may be in the range of 0.015 to 0.075.

FIG. 3I shows yaw stage 208 without OPFE 204 in the Yaw_{Max}-state with respect to yaw rotation axis 222. FIG. 3I also shows the position of magnet 306 relative to MFMD 308 in this state.

FIG. 3J shows a top part of folded camera module 200 with OPFE 204 shown in the Yaw_{Min}-state with respect to yaw rotation axis 222 pitch rotation direction. “Yaw_{Min}-state” refers here to an OPFE yaw rotation state which represents a second extreme (here, a minimum) yaw rotation angle. In the Yaw_{Min}-state, OPFE 204 is located at a minimum distance Y_{Min} measured along the y-axis, a first minimum distance X1_{Min} measured along the x-axis, and a second minimum distance X2_{Min} measured along the x-axis away from an inner boundary of frame 218, as shown.

FIG. 3K shows yaw stage 208 without OPFE 204 in the “Yaw_{Min}-state with respect to yaw rotation axis 222. FIG. 3K also shows the position of magnet 306 relative to MFMD 308 in this state.

In FIG. 3H and FIG. 3J it is visible that a certain part of yaw stage 208 can enter one of second notch 338 and third notch 340 at a position marked 346 or enter fourth notch 342 and fifth notch 344 at a position marked 348. This is advantageous for achieving a compact folded camera module.

FIG. 3L shows a VCM disclosed herein and numbered 350 in a perspective view. FIG. 3M shows VCM 350 included in folded camera module 200 in a bottom view. FIG. 3N shows VCM 350 included in OPFE holder 206 in a perspective bottom view. VCM 350 is operational to actuate a rotational movement of OPFE 204 around both yaw rotation axis 222 and pitch rotation axis 224. VCM 350 includes a first magnet 352 and a second magnet 354 (both fixedly coupled to yaw stage 208) as well as a first coil 356 and a second coil 358 (both fixedly coupled to frame 218). In addition, VCM 350 includes a first yoke (or preload yoke) 360 and a second yoke (or preload yoke) 362. Both yokes are fixedly coupled to frame 218. The yokes are operational for returning VCM 350 to a zero-position and to prevent disengagement of the parts included in OPFE holder 206. First magnet 352 has a first magnet dead zone (DZ) 352 and second magnet 354 has a second magnet DZ 355. As shown in FIG. 3M and approximately, pitch rotation axis 224 coincides with first magnet DZ 352 and second magnet DZ 355. First magnet 352 and second magnet 354 together cover (or use) a relatively large bottom area of OPFE holder 206. The fact that the magnets cover a relatively large bottom area of OPFE holder 206 is advantageous in that it allows a relatively strong and fast, yet still compact VCM. This is enabled by locating the first and second ball bearings at the second floor. A free space or free volume created in the first floor can be used to position the magnets.

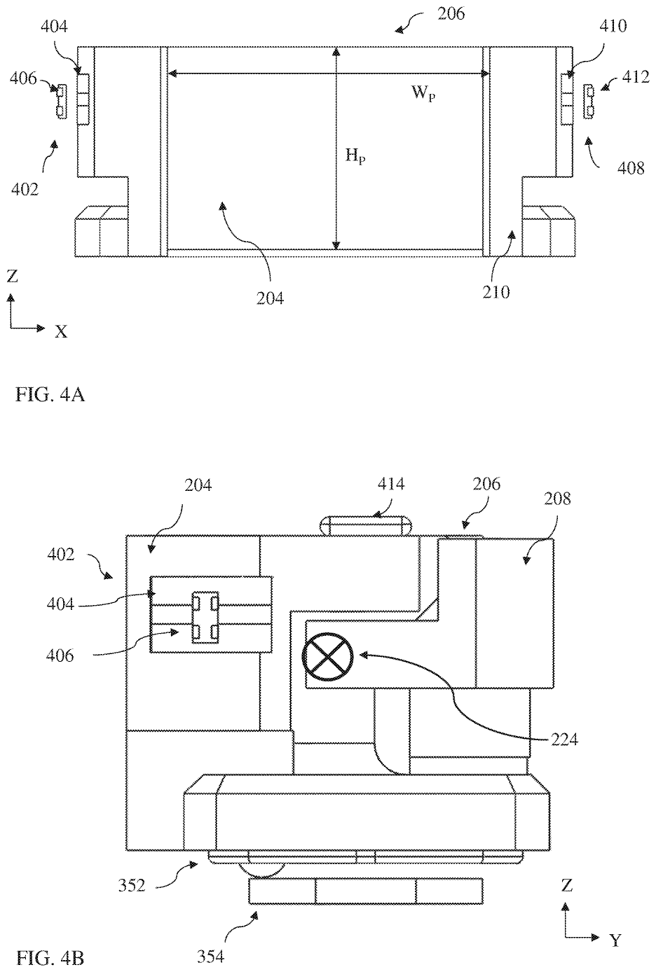

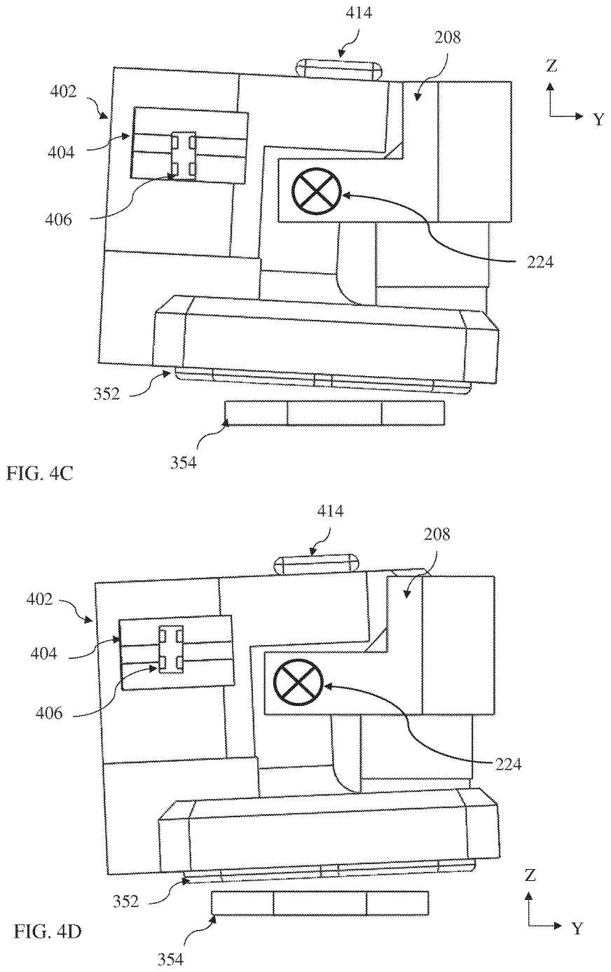

FIG. 4A shows pitch stage 210 and OPFE holder 206 with OPFE 204 in a front view. Pitch stage 210 includes a first pitch PSU 402 having a first pitch magnet 404 and a first pitch MFMD 406, as well as a second pitch PSU 408 having a second pitch magnet 410 and a second pitch MFMD 412.

FIG. 4B shows pitch stage 210 with OPFE 204 in a side view. OPFE 204 is shown in a “pitch zero state” with respect to a pitch rotation direction. “Pitch zero-state” refers here to an OPFE pitch rotation state that represents a center of a pitch rotation stroke defined by a minimum pitch rotation angle Pitch_{Min} and a maximum pitch rotation angle Pitch_{Max}. In the pitch zero-state, first pitch PSU 402 is in a zero-state. OPFE holder 206 includes a shock (or drop) absorber mechanism 414. Shock absorber mechanism 414 is operational to prevent yaw stage 208 and pitch stage 210 from disengaging from each other and/or from OPFE holder 206. Pitch rotation axis 224 is oriented parallel to the x-axis (i.e. perpendicular to the coordinate system shown).

First pitch PSU 402 and second pitch PSU 408 are located concentrically with respect to yaw rotation axis 222. It is noted that first pitch PSU 402 and second pitch PSU 408 are located at a relatively large distance from each other, and in addition, they are located at a relatively large distance from Yaw PSU 304. This is advantageous as there is virtually no electromagnetic crosstalk between each of yaw PSU 304, first pitch PSU 402 and second pitch PSU 408. With respect to a direction along the y-axis, pitch rotation axis 224 is located (or positioned) within an area that also includes OPFE 204.

FIG. 4C shows pitch stage 210 in a side view with OPFE 204 shown in a “Pitch_{Max}-state” with respect to a pitch direction. “Pitch_{Max}-state” refers here to an OPFE pitch rotation state that represents a maximum pitch rotation angle. In Pitch_{Max}-state, first pitch PSU 402 is in a maximum-state.

FIG. 4D shows pitch stage 210 in a side view with OPFE 204 shown in a “Pitch_{Min}-state” with respect to a pitch rotation direction. “Pitch_{Min}-state” refers here to an OPFE pitch rotation state that represents a minimum pitch rotation angle. In Pitch_{Min}-state, first pitch PSU 402 is in a minimum-state.

In FIG. 3N, it is visible that magnet 404 has a circular shape. The circular shape may be approximately so that a shape of magnet 404 is concentric with respect to the pivot point. The circular shape is advantageous for an accurate first pitch PSU 402. This is because the distance between magnet 404 and MFMD 406 is relatively constant when performing rotation around the Yaw rotation axis. In other embodiments, magnet 404 may have a rectangular (or “flat”) shape. The flat shape may be advantageous for a low cost folded camera module 200. Pitch stage 210 can be moved relative to yaw stage 208 by means of two ball-bearings: a first ball-bearing is formed by confining a fourth ball (not shown) within a fourth volume formed by groove 314 (included in yaw stage 208) and a groove (not shown, included in pitch stage 210), a second ball-bearing is formed by confining a fifth ball (not shown) within a fifth volume formed by cavity 316 (included in yaw stage 208) and a cavity (not shown, included in pitch stage 210).

With reference to FIG. 3L and FIG. 3M, we note that VCM 350 is configured to actuate a rotation of OPFE 204 both around a yaw rotation axis such as yaw rotation axis 222 and around a pitch rotation axis such as pitch rotation axis 224. I.e. VCM 350 has a first operation mode operational to actuate a yaw rotation, and VCM 350 has a second operation mode operational to actuate a pitch rotation.

### Actuating Yaw Rotation

For rotating OPFE 204 in a yaw rotation direction, a current flowing through (or induced in) first coil 356 is directed opposite to a current flowing through coil 358.

### Actuating Pitch Rotation

For rotating OPFE 204 in a pitch rotation direction, a current flowing through (or induced in) first coil 356 is directed identical to a current flowing through coil 358.

Table 1 presents values and ranges of components disclosed herein. L_{M}, H_{M}, W_{M}, L_{P}, H_{P}, W_{P}, Y_{Min}, X1_{Min}, X2_{Min}, v-D_{PH} and h-D_{PH} are given in mm, Yaw_{Min}, Yaw_{Max}, Pitch_{Min}, Pitch_{Max}, Yaw_{FOV} and Pitch_{FOV} are given in degrees.

TABLE 1

| | Range | Preferred range |
|---|---|---|
| L_{M} | 10-50 | 15-35 |
| H_{M} | 4-15 | 5-10 |
| W_{M} | 5-20 | 7.5-15 |
| L_{P} | 2.5-15 | 4-8 |
| H_{P} | 2.5-15 | 4-8 |
| W_{P} | 3-20 | 5-10 |
| v-D_{PH} | 1-5 | 1.5-3 |
| h-D_{PH} | 1-5 | 2-4 |
| Yaw_{Min}/Yaw_{Max} | −10/0 | −6/6 |
| Pitch_{Min}/Pitch_{Max} | −5/5 | −3/3 |
| Yaw_{FOV} | −10/10 | −6/6 |
| Pitch_{FOV} | −10/10 | −6/6 |
| Y_{Min} | 0.25-5 | 0.5-2 |
| X1_{Min} | 0.5-5 | 1-3 |
| X2_{Min} | 0.5-5 | 1-3 |
| W_{P}/h-D_{PH} | 0.8-20 | 1.25-5 |
| H_{P}/v-D_{PH} | 0.5-15 | 1.33-2.67 |

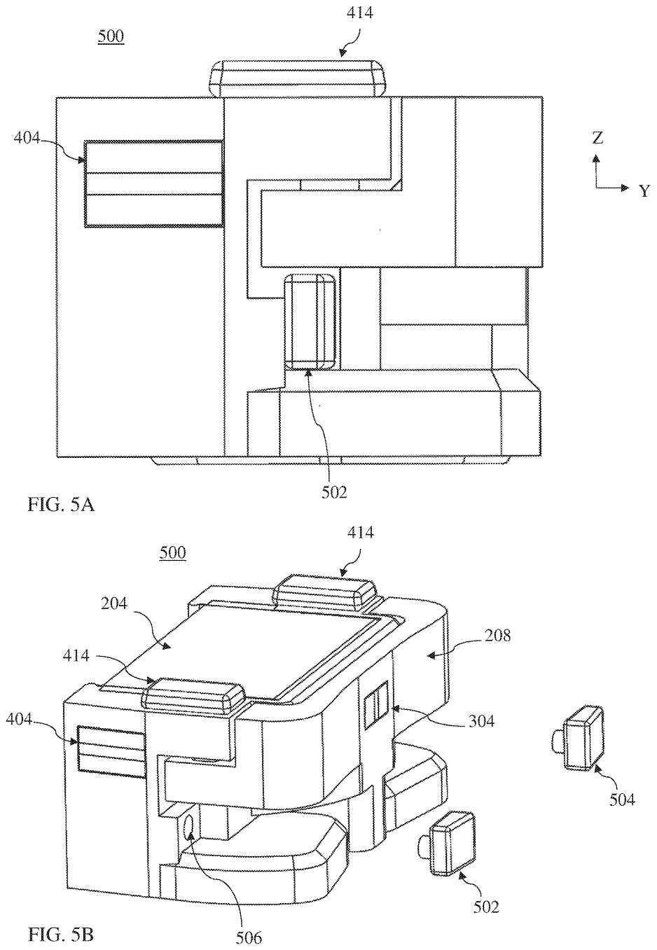

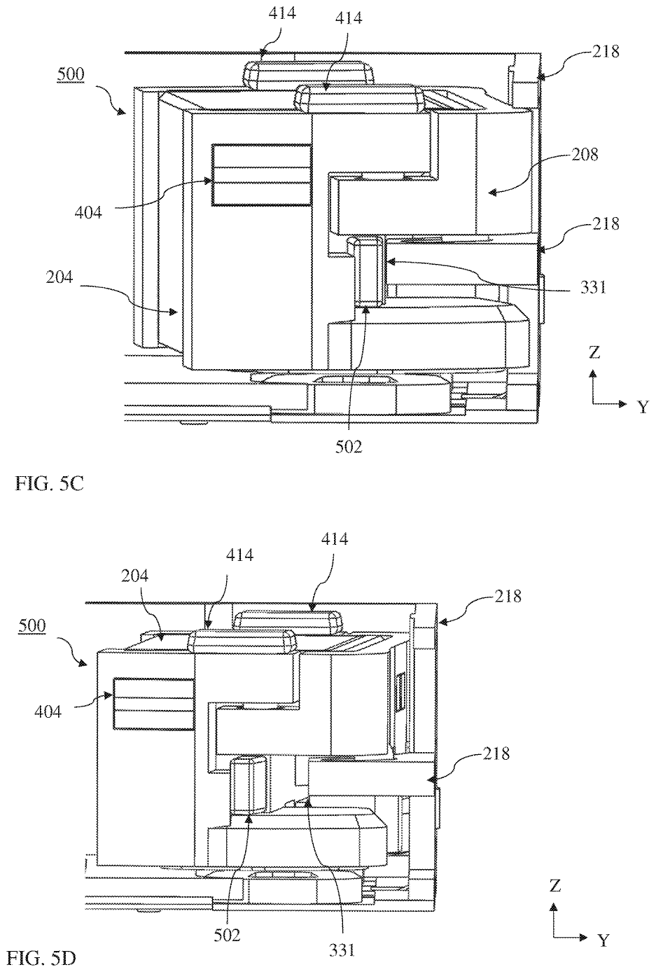

FIG. 5A shows another pitch stage numbered 500, operational to be included in a folded camera module such as folded camera module 200 and including an OPFE 204 in a side view. FIG. 5B shows pitch stage 500 in a perspective view. In FIGS. 5A-B, OPFE 204 is shown in a “yaw zero state” with respect to a yaw rotation axis. The yaw zero state is located at a center between a minimum Yaw rotation position and a maximum Yaw rotation position (FIGS. 5C-D). Pitch stage 500 includes a first stopper 502 and a second stopper 504, which both are fixedly coupled to pitch stage 500.

FIG. 5B shows an assembly of first stopper 502 and a second stopper 504. Pitch stage 500 includes a hole 506, which is operational to receive stopper 502. Entering (or pushing) stopper 502 into hole 506 may suffice to fixedly couple stopper 502 to pitch stage 500. Pitch stage 500 also includes another hole (not shown), which is operational to receive stopper 504. Stopper 502 and stopper 504 may for example be made of rubber material.

FIG. 5C shows another pitch stage 500 included in frame 218 in the Yaw_{Min}-state. In the Yaw_{Min}-state, stopper 502 is in contact with front surface 331 of the first floor. This contact prevents a further rotation of pitch stage 500 in a Yaw rotation direction. FIG. 5D shows another pitch stage 500 included in frame 218 in the Yaw_{Max}-state. In the Yaw_{Max}-state, stopper 504 (not visible here) may be in contact with another front surface of the first floor, so that further rotation of pitch stage 500 in a Yaw rotation direction is prevented.

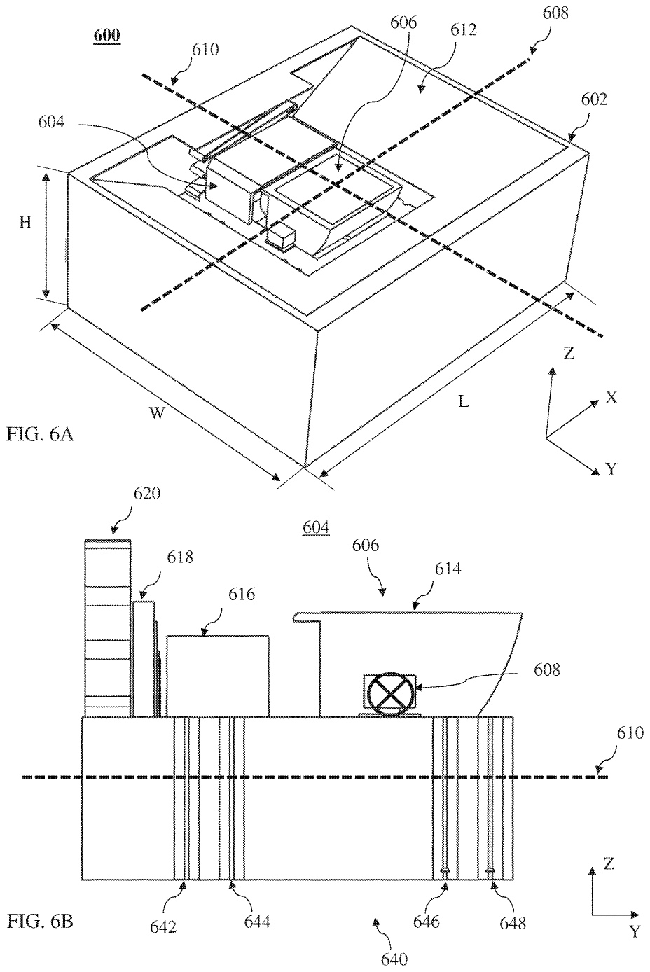

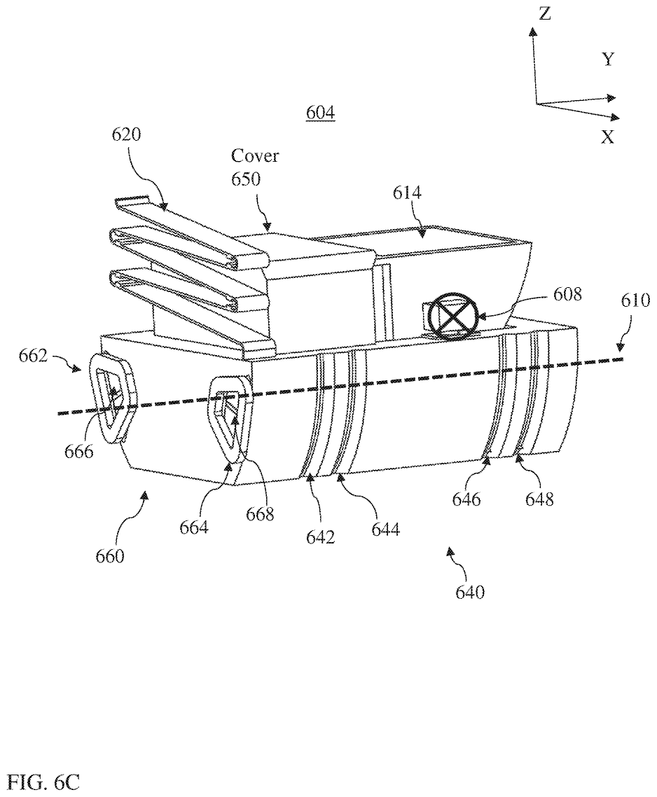

FIG. 6A shows a SZC 600 as disclosed herein in a perspective view. SZC 600 has a SZC FOV (“FOV_{SZC}”) and includes a static (or “fixed”) part 602, a moving part 604 and a SZC aperture 606. With respect to a host device including SZC 600, static part 602 does not move, and moving part 604 moves. Moving part 604 rotates along a first rotation axis 608 oriented parallel to the x-axis and a second rotation axis 610 oriented parallel to the y-axis. Static part 602 includes an opening (or “funnel”) 612.

FIG. 6B shows moving part 604 in a side view. SZC 600 includes a prism 614 which represents SZC aperture 606, a lens 616 and an image sensor 618. Moving part 604 also includes a flexure (or “flex cable”) 620 operational to electrically connect moving part 604 with static part 602. Moving part 604 also includes a set of rails 640 including a first rail 642, a second rail 644, a third rail 646 and a fourth rail 648. Set of rails 640 may interact with another set of rails (not shown) included in static part 602 to allow a rotational movement of moving part 604 relative to static part 602 around second rotation axis 610.

A height “H”, a width (“W”) and a length (“L”) of SZC 600 may be in the range of H=5 mm-30 mm, W=10 mm-80 mm and L=10 mm-100 mm, advantageously H=10 mm-25 mm, W=20 mm-50 mm and L=25 mm-75 mm. Lens 616 may have an effective focal length (“EFL”) in the range of 2 mm-40 mm, advantageously EFL is in the range of 2 mm-20 mm. Image sensor 618 may have an image sensor (full) diagonal (“SD”) in the range of 2 mm-20 mm, advantageously SD is in the range of 2 mm-15 mm. Here, SZC 600 has a FOV_{SZC} of about 75 degrees (about 28 mm 35 mm equivalent focal length). In other examples, FOV_{SZC} may be in the range of about 15 degrees to 100 degrees.

FIG. 6C shows moving part 604 in a perspective view. Here, prism 614, lens 616 and image sensor 618 are covered by a cover 650. SZC 600 includes a second rotation actuator 660, operational to actuate a rotation of moving part 604 around second rotation axis 610. Here, second rotation actuator 660 is a voice coil motor (VCM) that includes a first coil 662 and a second coil 664 which are both fixedly coupled to static part 602. Second rotation actuator 660 also includes a first magnet 666 and a second magnet 668 which are both fixedly coupled to moving part 604.

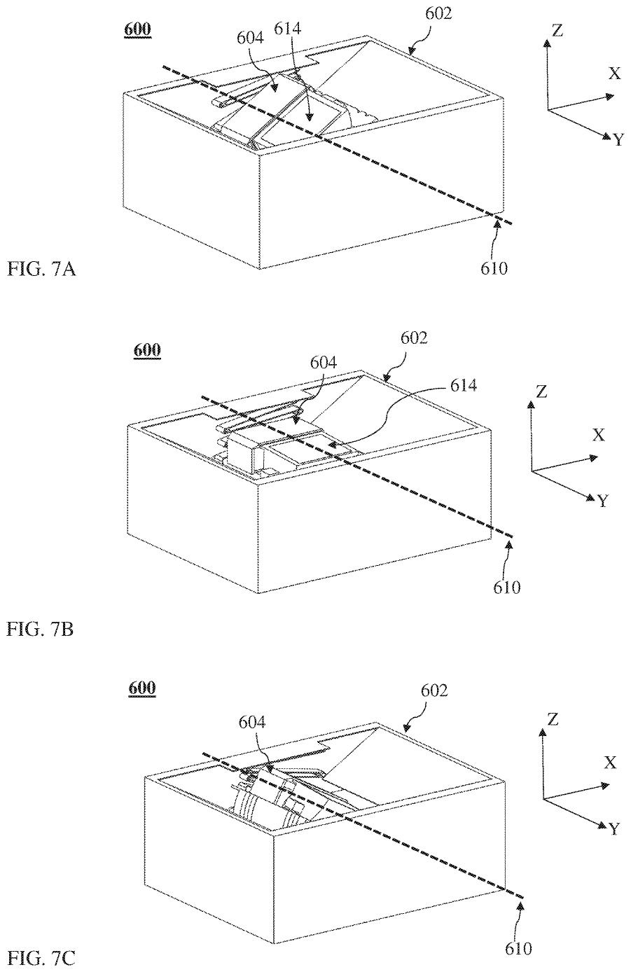

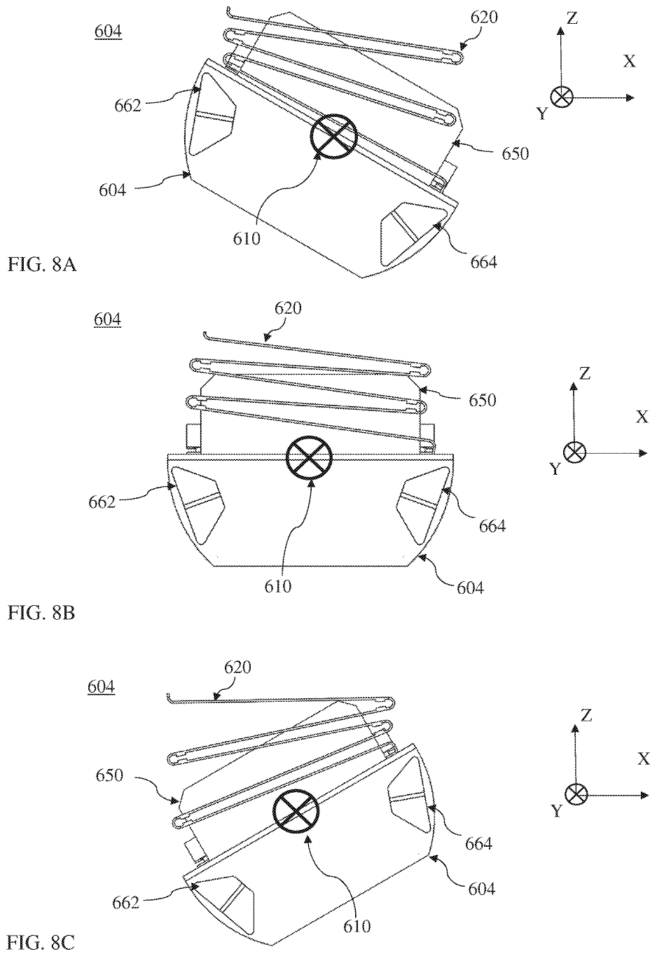

FIGS. 7A-C show SZC 600 in several rotation states with respect to second rotation axis 610 in a perspective view. FIGS. 8A-C show SZC 600 in several rotation states with respect to the second rotation axis 610 in a perspective view. FIG. 7A and FIG. 8A respectively show SZC 600 in in a first extreme rotation state. FIG. 7B and FIG. 8B respectively show SZC 600 in a center rotation state. In general, and with reference to a dual camera including SZC 600 and a Wide camera having a FOV_{W}>FOV_{SZC}, in a center rotation state, FOV_{SZC} is centered in FOV_{W} with respect to second rotation axis 610. FIG. 7C and FIG. 8C respectively show SZC 600 in a second extreme rotation state. The first and the second extreme rotation state with respect to the second rotation axis 610 may correspond to a rotation in the range of ±10 degrees to ±45 degrees, for example ±30 degrees or ±25 degrees. In some examples, the Wide camera may capture Wide image data of FOV_{W}. A camera controller may be configured to analyze the Wide image data and scan a scene with FOV_{SZC} based on the analysis of Wide image data.

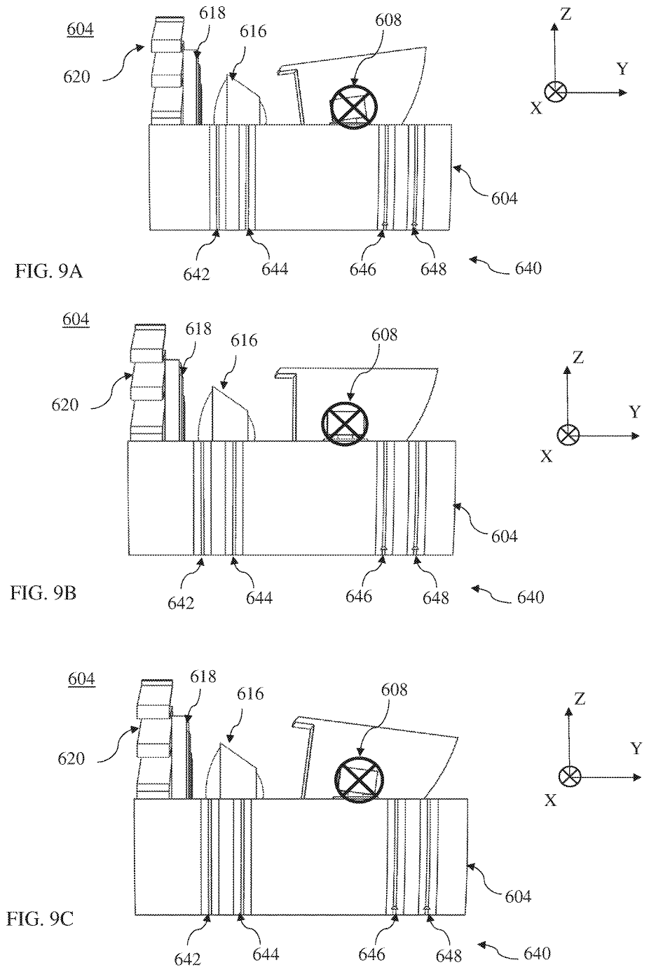

FIGS. 9A-C show SZC 600 in several rotation states with respect to first rotation axis 608 in a side view. FIG. 9A shows SZC 600 in a first extreme rotation state. FIG. 9B shows SZC 600 in a center rotation state. In general, and with reference to a dual camera including SZC 600 and a Wide camera, in a center rotation state, FOV_{SZC} is centered in FOV_{W} with respect to first rotation axis 608. FIG. 9C shows SZC 600 in a second extreme rotation state. The first and the second extreme rotation state with respect to the first rotation axis 608 may correspond to a rotation in the range of ±5 degrees to ±30 degrees, for example ±7.5 degrees or ±15 degrees. We note that SZC 600 does not create point-of-view aberrations, which is advantageous.

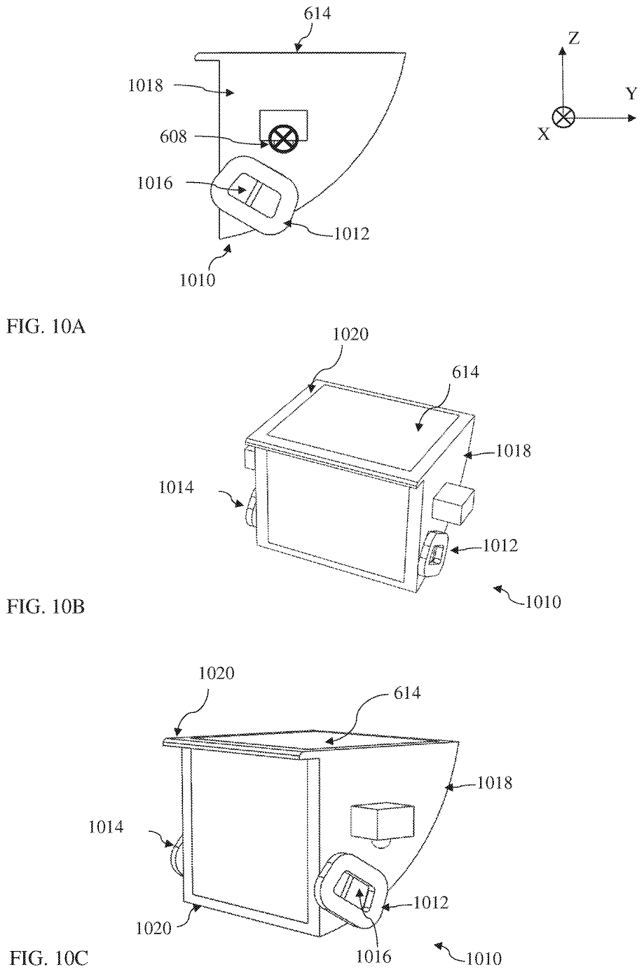

FIG. 10A shows parts of moving part 604 in a side view. FIG. 10B shows the parts of moving part 604 in a first perspective view. FIG. 10C shows the parts of moving part 604 in a second perspective view. SZC 600 includes a first rotation actuator 1010, operational to actuate a rotation of prism 614 around first rotation axis 608. Here, first rotation actuator 1010 is a VCM that includes a first coil 1012 and a second coil 1014 which are both fixedly coupled to moving part 604. First rotation actuator 1010 also includes a first magnet 1016 and a second magnet (not visible) which are both fixedly coupled to prism 614. Prism 614 is included in and fixedly coupled to a prism holder 1018. Prism holder 1018 includes a stray light mask 1020 operational to prevent undesired stray light from reaching image sensor 618.

While this disclosure has been described in terms of certain embodiments and generally associated methods, alterations and permutations of the embodiments and methods will be apparent to those skilled in the art. The disclosure is to be understood as not limited by the specific embodiments described herein, but only by the scope of the appended claims.

Unless otherwise stated, the use of the expression “and/or” between the last two members of a list of options for selection indicates that a selection of one or more of the listed options is appropriate and may be made.

It should be understood that where the claims or specification refer to “a” or “an” element, such reference is not to be construed as there being only one of that element.

Furthermore, for the sake of clarity the term “substantially” is used herein to imply the possibility of variations in values within an acceptable range. According to one example, the term “substantially” used herein should be interpreted to imply possible variation of up to 5% over or under any specified value. According to another example, the term “substantially” used herein should be interpreted to imply possible variation of up to 2.5% over or under any specified value. According to a further example, the term “substantially” used herein should be interpreted to imply possible variation of up to 1% over or under any specified value.

All patents and/or patent applications mentioned in this specification are herein incorporated in their entirety by reference into the specification, to the same extent as if each individual reference was specifically and individually indicated to be incorporated herein by reference. In addition, citation or identification of any reference in this application shall not be construed as an admission that such reference is available as prior art to the present invention.

What is claimed is:

1. A folded camera module, comprising:
an optical path folding element (OPFE) for folding light from a first optical path toward a second optical path having an OPFE height H_{P} measured along the first optical path;
a lens having an effective focal length EFL in a range of 5-40 mm;
an image sensor;
a module frame surrounding the folded camera module, the module frame having a module height H_{M} measured along a direction parallel to the first optical path; and
an OPFE actuator including a voice coil motor (VCM) for rotating the OPFE around a first rotation axis and around a second rotation axis that is perpendicular to the first rotation axis to move a field-of-view FOV of the folded camera in two directions,
wherein the FOV movement is by more than ±1 degrees around each of the first OIS direction and the second OIS direction,
wherein H_{M}<H_{P}+4 mm,
and wherein a ratio H_{P}/H_{M} is larger than 0.6.

2. The folded camera module of claim 1, wherein the FOV movement is for performing optical image stabilization (OIS) around, respectively, a first OIS direction and a second OIS direction.

3. The folded camera module of claim 1, wherein the FOV movement is for scanning a scene with the FOV of the folded camera.

4. The folded camera module of claim 1, wherein H_{M}<H_{P}+2.5 mm.

5. The folded camera module of claim 1, wherein H_{M}<H_{P}+2 mm.

6. The folded camera module of claim 1, wherein H_{M} is in the range of 4-15 mm.

7. The folded camera module of claim 1, wherein H_{M} is in the range of 5-10 mm.

8. The folded camera module of claim 1, wherein the OPFE actuator includes a single VCM for rotating the OPFE.

9. The folded camera module of claim 8, wherein the single VCM includes a first coil and a second coil, wherein for rotating the OPFE around the first rotation axis a current in the first coil flows in an opposite direction than a current in the second coil, and wherein for rotating the OPFE around the second rotation axis a current in the first coil flows in an identical direction with a current in the second coil.

10. The folded camera module of claim 1, wherein the OPFE actuator includes three ball-bearings, and wherein one ball-bearing is positioned closer to a bottom of module frame than the other two ball-bearings.

11. The folded camera module of claim 1, wherein the module frame having an inner wall pointing towards the OPFE, and wherein a minimum distance Y_{Min} between the OPFE and the inner wall in an extreme rotation OPFE position measured along a direction parallel to the second optical path fulfills Y_{Min}≤1.25 mm.

12. The folded camera module of claim 11, wherein the module frame has a module length L_{M} measured along a direction parallel to the second optical path, and wherein Y_{Min}/L_{M}≤0.075.

13. The folded camera module of claim 1, wherein the module frame having an inner wall pointing towards the OPFE, and wherein a minimum distance X_{MIN} between the OPFE and the inner wall in an extreme rotation OPFE position measured along a direction perpendicular to both the first optical path and the second optical path fulfills X_{Min}≤2.25 mm.

14. The folded camera module of claim 13, wherein the module frame has a module width W_{M} measured along a direction perpendicular to both the first optical path and the second optical path, and wherein X_{Min}/W_{M}≤0.25.

15. The folded camera module of claim 1, wherein the FOV movement is by more than ±2 degrees around each of the two directions.

16. The folded camera module of claim 1, wherein the FOV movement is by more than ±5 degrees around each of the two directions.

17. The folded camera module of claim 1, wherein the OPFE is a prism.

18. The folded camera module of claim 1, wherein the OPFE has an OPFE width W_{P} measured along a direction perpendicular to both the first optical path and the second optical path, wherein in a zero-rotation OPFE position the OPFE is located at a horizontal distance h-D_{PH} and at a vertical distance v-D_{PH} away from an inner wall of the module frame, and wherein W_{P}/h-D_{PH}>3 and H_{P}/v-D_{PH}>3.

19. The folded camera module of claim 1, wherein the EFL is in the range of 10-25 mm.

20. The folded camera module of claim 1, wherein the folded camera module is included in a mobile device.
